(19) United States
(12) Patent Application Publication
(10) Pub. No.: US 2013/0014709 A1
(43) Pub. Date: Jan. 17, 2013

(54) INDIRECT STEAM GENERATION SYSTEM AND PROCESS

(71) Applicant: David William LARKIN, Bartlesville, OK (US)

(72) Inventor: David William LARKIN, Bartlesville, OK (US)

(73) Assignee: CONOCOPHILLIPS COMPANY, Houston, TX (US)

(21) Appl. No.: 13/547,565

(22) Filed: Jul. 12, 2012

Related U.S. Application Data
(60) Provisional application No. 61/507,185, filed on Jul. 13, 2011.

(51) Int. Cl. F22B 1/02; F23C 10/26; F27B 15/00

(52) U.S. Cl. 122/28; 432/27; 432/215

(57) ABSTRACT

Embodiments relate to production of hydrocarbons from an underground formation. More specifically, embodiments relate to a system and method for generating steam for heavy hydrocarbon production process. The indirect steam generation system uses moving hot solids (e.g. sand, metal spheres, etc) to produce steam from non-treated (dirty) boiler feed water. The solids are then transported to another vessel (e.g.combustor) where they are reheated and cleaned of contaminants before being recycled back to the boiler to produce more steam.

### CROSS-REFERENCE TO RELATED APPLICATIONS

This application is a non-provisional application which claims benefit under 35 USC §119(e) to U.S. Provisional Application Ser. No. 61/507,185 filed Jul. 13, 2011, entitled “Indirect Steam Generation System and Process,” which is incorporated herein in its entirety.

### STATEMENT REGARDING FEDERALLY SPONSORED RESEARCH OR DEVELOPMENT

None.

### FIELD OF THE DISCLOSURE

Embodiments of the current disclosure relate to production of hydrocarbons from an underground formation. More specifically, embodiments of the current disclosure relate to a system and method for generating steam for heavy hydrocarbon production process.

### BACKGROUND OF THE DISCLOSURE

Conventional processes for production of heavy hydrocarbons from heavy oil or bitumen containing formations utilize energy and cost intensive techniques. Expense of producing steam through steam generation and expensive boiler feed water preparation contribute to inefficiencies in such techniques.

Steam Assisted Gravity Drainage (SAGD) for heavy oil production has been used in Canada, wherein the heavy oil or bitumen is produced by the SAGD process through injection of high pressure steam into the heavy oil or bitumen. The heat from the steam reduces the oil's viscosity which enables it to flow down to the producer wellbore where it is transported to the surface by pumps or lift gas.

Commonly, SAGD steam is produced on the surface using Once Through Steam Generators (OTSGs). The boiler feed water to the OTSGs, however, has to be treated first by the SAGD De-oiling and Water Treatment plants to prevent steam boiler fouling. The SAGD process is therefore capital expense and operational expense intensive due to the significant number of surface facilities (e.g. de-oiling and water treatment plants) required and their subsequent chemical and energy usage.

A need exists for improved system and processes for efficient production of heavy hydrocarbons from a formation.

### BRIEF SUMMARY OF THE DISCLOSURE

Embodiments of the current disclosure relate to production of hydrocarbons from an underground formation. More specifically, embodiments of the current disclosure relate to a system and method for generating steam for heavy hydrocarbon production process. The indirect steam generation system according to the current invention uses moving hot solids (e.g. sand, metal spheres, etc) to produce steam from non-treated (dirty) boiler feed water. The solids would then be transported to another vessel (e.g.combustor) where they would be reheated and cleaned of contaminants before being recycled back to the boiler to produce more steam.

According to one embodiment, an indirect steam generation system for hydrocarbon production process includes an injector configured for conveying a feed water stream and a moving solids stream into a steam generator to produce a mixture stream, a steam separator for separating the mixture stream into at least a steam stream and a first hot solids stream, a combustion vessel for combusting the first hot solids stream with an oxygen or oxygen containing gas stream and a fuel stream to produce at least a second hot solids stream and a flue gas stream, and a transport mean for recycling the second hot solids stream into the steam generator. Further, the feed water stream comprises, consists of, or consists essentially of liquid water and at least about 1,000 ppm total dissolved solids and at least 100 ppm organic compounds.

According to another embodiment, a process includes injecting a feed water stream and a moving solids stream into a steam generator to produce a mixture stream, separating the mixture stream in a steam separator to form at least a steam stream and a first hot solids stream, combusting the first hot solids stream with an oxygen or oxygen containing gas stream and a fuel stream in a combustion vessel to produce at least a second hot solids stream and a flue gas stream, and recycling the second hot solids stream into the steam generator. Further, the feed water stream comprises, consists of, or consists essentially of liquid water and at least about 1,000 ppm total dissolved solids and at least 100 ppm organic compounds.

### BRIEF DESCRIPTION OF THE DRAWINGS

The invention, together with further advantages thereof, may best be understood by reference to the following description taken in conjunction with the accompanying drawings.

FIG. 1 is a simplified diagram of an indirect steam boiler system according to one embodiment of the invention.

FIG. 2 is a simplified diagram of an indirect steam boiler system according to another embodiment of the invention.

FIG. 3 is a simplified diagram of an indirect steam boiler system with automated valves according to another embodiment of the invention.

FIG. 4 is a simplified diagram of an indirect steam boiler system with electricity generation according to another embodiment of the invention.

FIG. 5 is a simplified diagram of an oxy-indirect steam boiler system according to another embodiment of the invention.

FIG. 6 is a simplified diagram of an oxy-indirect steam boiler system according to yet another embodiment of the invention.

### DETAILED DESCRIPTION OF THE DISCLOSURE

Turning now to the detailed description of the embodiments of the present invention. It should be understood that the inventive features and concepts may be manifested in other arrangements and that the scope of the invention is not limited to the embodiments described or illustrated. The scope of the invention is intended only to be limited by the scope of the claims that follow.

Embodiments of the current disclosure relate to production of hydrocarbons from an underground formation. More specifically, embodiments of the current disclosure relate to a system and method for generating steam for heavy hydrocarbon production process. The indirect steam generation system according to the current invention uses moving hot solids (e.g. sand) to produce steam from non-treated (dirty) boiler feed water. The solids would then be transported to another vessel (e.g.combustor) where they would be reheated and cleaned of some contaminants before being recycled back to the boiler to produce more steam.

As used herein, heavy hydrocarbons of hydrocarbon formation(s) can include any heavy hydrocarbons having greater than 10 carbon atoms per molecule. Further, the heavy hydrocarbons of the hydrocarbon formation can be a heavy oil having a viscosity in the range of from about 100 to about 10,000 centipoise, and an API gravity less than or equal to about 22° API; or can be a bitumen having a viscosity greater than about 10,000 centipoise, and an API gravity less than or equal to about 22° API.

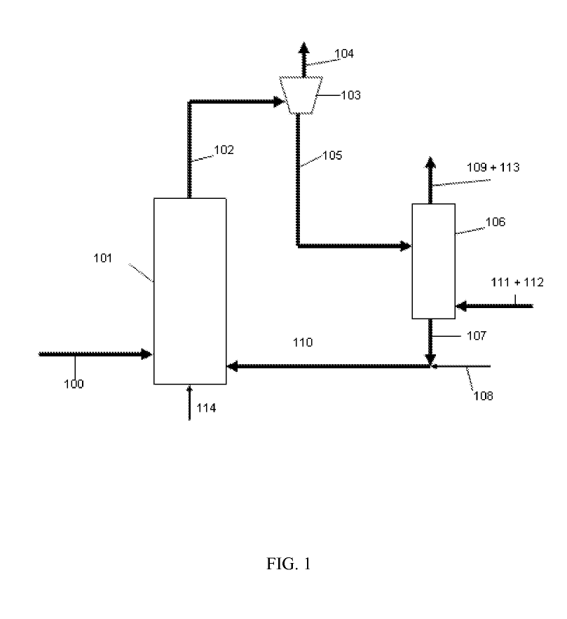

According to one embodiment of the inventive indirect steam generation system as shown in FIG. 1, there are provided one or more injectors (not shown) configured for conveying a feed water stream 100 and a moving solids stream 110 into a steam generator 101 to produce a mixture stream 102 comprising steam and hot solids.

The system according to FIG. 1 may further include an inlet (not shown) configured for conveying a supplementary fluids or gas stream (e.g. steam) 114 to provide additional fluidization at the bottom of the steam generator 101.

In some embodiments, the feed water stream is a non-treated (dirty) water stream that comprises, consists of, or consists essentially of liquid water and at least about 1,000 ppm, or at least about 5000 ppm, or at least about 10,000 ppm, or at least about 45,000 ppm total dissolved solids. The non-treated (dirty) water stream may further comprise at least about 100 ppm, or at least about 500 ppm, or at least about 1000 ppm, or at least about 15,000 ppm organic compounds. The non-treated water may further comprise at least about 1000 ppm free oil.

In some embodiments, the feed water comes from water that has come into contact with hydrocarbons from an underground formation.

The moving solid useful for this invention includes but is not limited to geldart A solids, geldart B solids, or any mixture thereof. Exemplary geldart A or B solids may be fluidize catalytic cracking catalyst, various types of sand, or any mixture thereof.

A steam generator useful for the current invention includes but is not limited to fixed or circulating fluidized solid beds, moving solid beds, fixed solid beds, or risors. According to one embodiment of the invention as shown in FIG. 1, a steam generator 101 is a gas-fluid contactor with solids capable of mixing gas and fluids with solids.

Referring to FIG. 1, the mixture stream 102 is further being transported to a steam separator 103 which separates the mixture stream 102 into at least a steam stream 104 and a first hot solids stream 105. According to one embodiment of the current invention, such steam separator may be located downstream from the steam generator 101 and receives the mixture stream via a conduit.

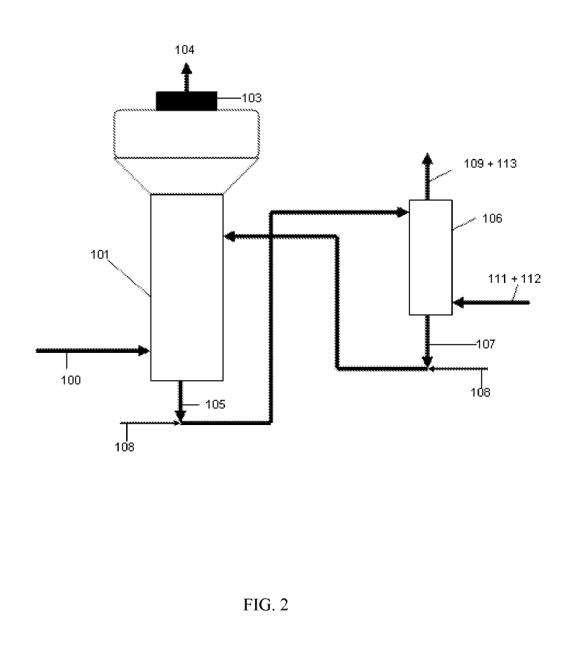

According to another embodiment of the current invention as shown in FIG. 2, the steam separator 103 may also be located on the top end of the steam generator 101 and allow the steam stream 104 to leave the steam generator 101 while separating out the first hot solids stream 105 inside the steam generator 101. The first hot solids stream is sent to combustion vessel 106 via lift gas.

The steam separator 103 according to various embodiments of the current invention includes but is not limited to a group consisting of cyclones or filters.

According to one embodiment of the current invention as shown in FIG. 1, the separated first hot solids stream 105 is further transported to the combustion vessel 106 wherein the first hot solids stream 105 is combusted with oxygen or oxygen containing gas stream 111 and a fuel stream 112, thereby, forming a second hot solids stream 107 and a flue gas stream 109.

The temperature of the second hot solid stream 107 is at least 50° C. or 100° C. higher than the first hot solids stream 105 discussed above, and the content of organic contaminants is at least 50% or 90% less than those in the first solid stream.

During the combustion, contaminants such as organic molecules are partially or fully converted into CO₂ and water, and some salts on the solids 105 come off into small light solid flakes 113 due to solid surface friction with other solid particles. The superficial velocity of the flue gas carries some of these light flakes out the top of the combustion vessel 106. The resulting second hot solids stream 107 along with push gas 108 is then recycled back to the steam generator 101 via any transporting means to produce more steam.

According to another embodiment of the current invention, solids may also be removed from the system and replaced with fresh solids as another approach to remove organic and inorganic contanimants from the process.

A combustion vessel 106 is a gas-fluid contactor with solids capable of mixing gas-fluids with solids. A combustion vessel 106 useful for the current invention includes but is not limited to fixed or circulating fluidized solid beds, moving solid beds, or fixed solid beds.

The fuel gas stream 112 in accordance to some embodiments of the invention includes but is not limited to a fuel selected from at least one of hydrogen and hydrocarbons having from one to six carbon atoms per molecule.

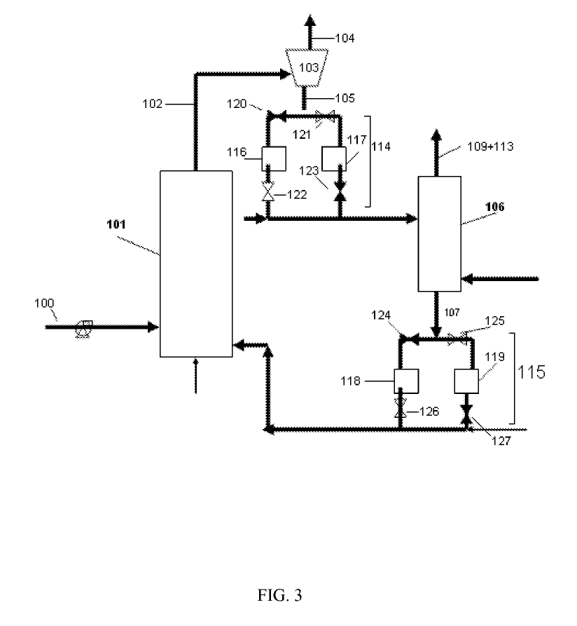

For some embodiments, the pressure in steam generator 101 and combustion vessel 106 may be controlled by automated valve lockhopper systems 114 and 115 as shown in FIG. 3. In general, lockhoppers in system 114 are able to receive solids at high pressure and change to a low pressure environment through an automated valving system before transferring the solids to combustion vessel 106. Lockhoppers in system 115 are able to receive solids at low pressure from the combustion vessel 106 and then change to a high pressure environment through an automated valving system before transferring the solids to steam generator 101.

According to one embodiment of the current invention as shown in FIG. 3, the pressure in the steam generator 101 is maintained from 200 psia to 1500 psia while the pressure in the combustion vessel 106 is maintained from 14.7 psia to 100 psia by a lockhopper automated valve systems 114. When going from a high pressure (200 psia-1500 psia) to a low pressure (14.7 psia-100 psia) environment, solids are transferred from steam separator 103 to lockhopper 117 through an open valve 121. Lockhopper 117 pressure is maintained 5 to 10 psi below separator 103's pressure while valve 121 is in the open position. Valve 123 is closed to maintain the pressure difference between steam generators 101 and combustion vessel 106. While lockhopper 117 is filling with solids, lockhopper 116 is draining solids at a pressure about 5 to 10 psi greater than combustion vessel's 106 pressures. While lockhopper 116 is draining solids valve 120 is closed and valve 122 is open. Once lockhopper 117 has filled with solids and lockhopper 116 is empty of solids, valves 121 and 122 are put in the closed position. In the case of lockhopper 116, it pressurizes up to a pressure about 5 to 10 psi less than the pressure in vessel 103 via a high pressure gas not shown in FIG. 3. Lockhopper 117 decreases its pressure via an automated venting system not shown in FIG. 3 to a pressure about 5 psi to 10 psi above the pressure in combustion vessel 106. Once both lockhoppers 116 and 117 are at their target pressure, valve 120 opens and valve 123 opens which enables lockhopper 116 to receive solids at high pressure and lockhopper 117 to drain solids at low pressure. This cycle then repeats itself in which lockhoppers 116 and 117 alternate between receiving solids at high pressure and draining solids at low pressure.

According to one embodiment of the current invention as shown in FIG. 3, the pressure in the steam generator 101 is maintained from 200 psia to 1500 psia while the pressure in the combustion vessel 106 is maintained from 14.7 psia to 100 psia by the lockhopper automated valve systems 115. When going from a low pressure (14.7 psia to 100 psia) to a high pressure (200 psia to 1500 psia) environment, solids are transferred from combustion vessel 106 to lockhopper 119 through open valve 125. Lockhopper 119 pressure is maintained 0 to 10 psi below combustion vessel 106's pressure while valve 125 is in the open position. Valve 127 is closed to maintain the pressure difference between steam generator 101 and combustion vessel 106. While lockhopper 119 is filling with solids, lockhopper 118 is draining solids at a pressure about 5 to 10 psi greater than steam generator's 101 pressure. While lockhopper 118 is draining solids valve 124 is closed and valve 126 is open. Once lockhopper 119 has filled with solids and lockhopper 118 is empty of solids, valves 125 and 126 are put in the closed position. In the case of lockhopper 119, it pressurizes up to a pressure about 5 to 10 psi greater than the pressure in steam generator 101 via a high pressure gas not shown in FIG. 3. Lockhopper 118 decreases its pressure through an automated venting system not shown in FIG. 3 to a pressure about 0 psi to 10 psi below the pressure in combustion vessel 106. Once both lockhoppers 118 and 119 are at their target pressure, valves 124 and 127 open which enable lockhopper 118 to receive solids at low pressure and lockhopper 119 to drain solids at high pressure. This cycle then repeats itself in which lockhoppers 118 and 119 alternate between receiving solids at low pressure and draining solids at high pressure.

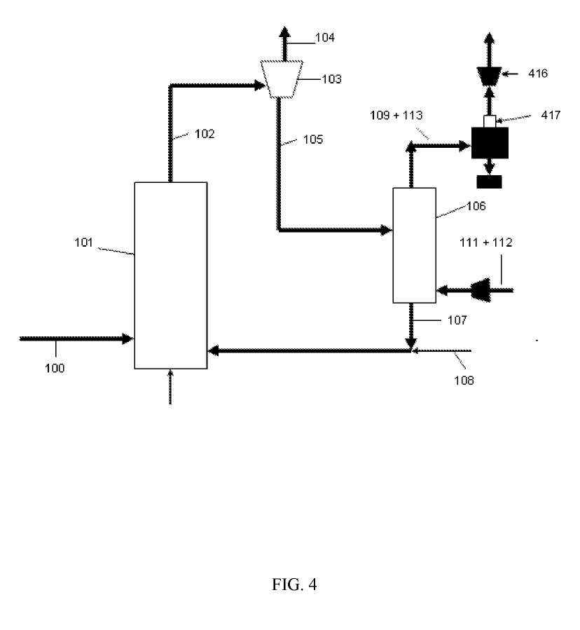

For some embodiments, the flue gas stream 109 produced from high pressure reaction in the combustion vessel 106 may be further sent to a turbine 416 for generating electricity as shown in FIG. 4. In some embodiments, there is also provided a seperator 417 such as a filter to separate the light solid flakes 113 from the flue gas stream 109 prior to feeding the flue gas stream 109 to the turbine 416.

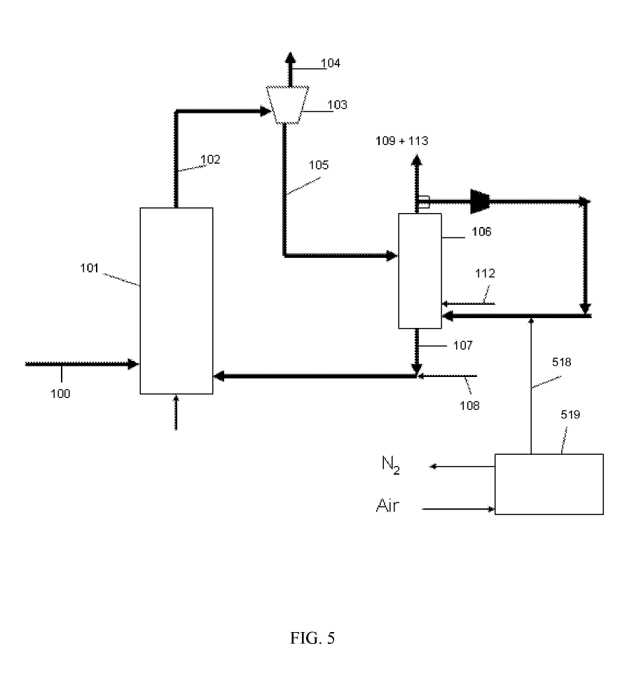

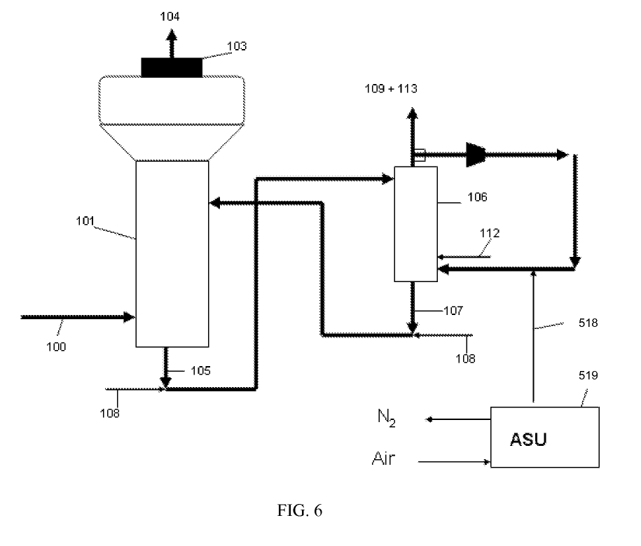

For some embodiments, the indirect steam generator may also be made CO₂ capture ready by combusting the fuel 112 with oxygen 518 instead of air as shown in FIGS. 5 and 6. Air seperating unit (ASU) 519 is one potential source for the oxygen.

For some embodiments as shown in all figures, the second hot solids stream is recycled to the steam generator via any type of suitable transport capable of transporting such second hot solid stream.

Systems described herein use non-treated (dirty) boiler feed water, which eliminates the capital expense and operational expense associated with de-oiling and water treatment plants. Commercial boilers with fixed heating surfaces are unable to use non-treated water due to fouling concerns. The systems also produce about 100% quality steam, thereby, not losing thermal energy to blowdown (typically, OTSGs requires 25% blowdown due to fouling concerns). The current inventive process may also have less of a plot footprint due to lower required residence times for steam generation.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims whiles the description, abstract and drawings are not to be used to limit the scope of the invention. The invention is specifically intended to be as broad as the claims below and their equivalents.

1. A process, comprising:
a) injecting a feed water stream and a moving solids stream into a steam generator to produce a mixture stream;
b) separating said mixture stream in a steam separator to form at least a steam stream and a first hot solids stream;
c) combusting said first hot solids stream with an oxygen containing gas stream and a fuel stream in a combustion vessel to produce a second hot solids stream and a flue gas stream, wherein pressure in the steam generator is higher than in the combustion vessel;
d) recycling said second hot solids stream into said steam generator, and wherein said feed water stream comprises at least 1000 ppm total dissolved solids and at least 100 ppm organic compounds.

2. The process of claim 1, wherein said first hot solids stream and said second hot solids stream comprises organic contaminants, wherein the organic contaminants in said second hot solids stream is at least 50% less than in said first solids stream, and wherein the temperature of said second hot solids stream is at least 50° C. higher than said first hot solids stream.

3. The process of claim 1, wherein said first hot solids stream and said second hot solids stream comprises organic contaminants, wherein the organic contaminants in said second hot solids stream is at least 90% less than in said first solids stream, and wherein the temperature of said second hot solids stream is at least 100° C. higher than said first hot solids stream.

4. The process of claim 1, wherein said moving solids stream comprises geldart A type solids, geldart B type solids, or a mixture thereof.

5. The process of claim 1, wherein said moving solids stream comprises sand, fluidized catalytic cracking catalyst, or a mixture thereof.

6. The process of claim 1, wherein said fuel gas stream comprises a fuel selected from at least one of hydrogen and hydrocarbons having from one to six carbon atoms per molecule.

7. The process of claim 1, wherein said steam generator is selected from a group consisting of fixed or circulating fluidized solid beds, moving solid beds, fixed solid beds, a risor, and any combination thereof

8. The process of claim 1, wherein said combustion vessel is selected from a group consisting of fixed or circulating fluidized solid beds, moving solid beds, fixed solid beds, and any combination thereof.

9. The process of claim 1, wherein both of said steam generator and said combustion vessel are gas-fluid contactors.

10. The process of claim 1, further comprising a step of conveying a supplementary fluids or gas stream to said steam generator.

11. The process of claim 1, further comprising a step of maintaining the pressure of said steam generator and said combustion vessel by automated valves, wherein the pressure in said steam generator is between 200 to 1500 psia and the pressure in said combustion vessel is between 14.7 to 100 psia.

12. The process of claim 1, further comprising a step of feeding said flue gas stream to a turbine to generate electricity.

13. A system, comprising:
a) an injector for injecting a feed water stream and a moving solids stream into a steam generator to produce a mixture stream;
b) a steam separator for separating said mixture stream into at least a steam stream and a first hot solids stream;
c) a combustor for combusting said first hot solids stream with an oxygen containing gas stream and a fuel stream to produce a second hot solids stream and a flue gas stream, wherein pressure in the steam generator is operable to be at a higher level than in the combustor;
d) a transport for recycling said second hot solids stream into said steam generator, and wherein said feed water stream comprises at least 1000 ppm total dissolved solids and at least 100 ppm organic compounds.

14. The system of claim 13, wherein said first hot solids stream and said second hot solids stream comprises organic contaminants, wherein the organic contaminants in said second hot solids stream is at least 50% less than in said first solids stream, and wherein the temperature of said second hot solids stream is at least 50° C. higher than said first hot solids stream.

15. The system of claim 13, wherein said first hot solids stream and said second hot solids stream comprises organic contaminants, wherein the organic contaminants in said second hot solids stream is at least 90% less than in said first solids stream, and wherein the temperature of said second hot solids stream is at least 100° C. higher than said first hot solids stream.

16. The system of claim 13, wherein said moving solids stream comprises geldart A type solids, geldart B type solids, or a mixture thereof.

17. The system of claim 13, wherein said moving solids stream comprises sand, fluidized catalytic cracking catalyst, or a mixture thereof.

18. The system of claim 13, wherein said fuel gas stream comprises a fuel selected from at least one of hydrogen and hydrocarbons having from one to six carbon atoms per molecule.

19. The system of claim 13, wherein said steam generator is selected from a group consisting of fixed or circulating fluidized solid beds, moving solid beds, fixed solid beds, a risor, and any combination thereof.

20. The system of claim 13, wherein said combustor is selected from a group consisting of fixed or circulating fluidized solid beds, moving solid beds, fixed solid beds, and any combination thereof.

21. The system of claim 13, wherein both of said steam generator and said combustor are gas-fluid contactors.

22. The system of claim 13, further comprising a supplementary fluids or gas stream for conveying to said steam generator.

23. The system of claim 13, further comprising automated valves configured to maintain the pressure in said steam generator between 200 to 1500 psia and the pressure in said combustor between 14.7 to 100 psia.

24. The system of claim 13, further comprising a turbine to generate electricity and fed with said flue gas stream.
